(19) United States
(12) Patent Application Publication
(10) Pub. No.: US 2013/0323692 A1
(43) Pub. Date: Dec. 5, 2013

(54) Education Game Systems and Methods

(71) Applicants: Joseph Freimuth, Los Angeles, CA (US); Christopher Anthony, New York, NY (US)

(72) Inventors: Joseph Freimuth, Los Angeles, CA (US); Christopher Anthony, New York, NY (US)

(73) Assignee: NERDCOACH, LLC, Wilton, CT (US)

(21) Appl. No.: 13/904,630

(22) Filed: May 29, 2013

Related U.S. Application Data
(60) Provisional application No. 61/652,841, filed on May 29, 2012.

(51) Int. Cl. G09B 5/00

(52) U.S. Cl. CPC G09B 5/00
USPC 434/169

(57) ABSTRACT

The present disclosure provides education game systems and methods that display key words and distractor words simultaneously across a user interface such that a student can practice identifying and applying key words to improve their overall score on standardized exams.

### CROSS-REFERENCE TO RELATED APPLICATIONS

This application incorporates by reference and claims priority to U.S. Provisional Application No. 61/652,841 filed on May 29, 2012.

### BACKGROUND OF THE INVENTION

The present subject matter relates generally to systems and methods for electronic educational games.

Obtaining high scores on standardized tests is extremely important to a student's future. With the correct score, a student will have the opportunity to attend a variety of prestigious universities in preparation for a career path of their choosing. Examples of standardized tests include the Scholastic Aptitude Test (SAT), Medical College Admission Test (MCAT), Law School Admission Test (LSAT), Graduate Record Examination (GRE), and American College Testing (ACT), among others.

One factor which is thought to improve a student's performance on these tests is coaching or formal test preparation efforts. In fact, an entire test preparation industry has arisen to help students improve their scores on these exams. Traditional services include classroom-based courses, tutoring, stand-alone printed publications, computer based materials and online courses. Unfortunately, most of the current methods for preparing students for exams are costly, inefficient and inconvenient.

For example, many prep courses have a qualified instructor that provides students with an overview of the exam and some of the tools students need to increase their score. The instructors typically walk the students through various portions of the exam and provide a surface overview of testing strategies. Notwithstanding the benefits of these programs, courses alone may not be enough for students to reach their maximum score on the exam.

One-on-one tutoring is also suggested for students to supplement the prep courses. However, tutoring is both time consuming and expensive. In addition, students often receive the advice to take as many practice exams outside of the prep course as they can before the date of the test. However, taking a full practice exam is not always logistically possible. The practice exams may take up to two or three hours and require the student to find a quiet room with a desk for working problems on scratch paper. Students rarely have the time in their schedule to block off hours at a time to practice. Further, students often need to study in environments that are not necessarily conducive to a taking a practice exam or answering sample exam questions.

Further, the feedback received from those companies that offer sample exams and diagnostic feedback of the student's performance is typically simplistic. The feedback is usually defined from a conventional testing perspective and is merely based on the number of incorrect answers. Therefore, the simplistic diagnosis is reduced to recommending the student to review certain types of problems.

Many test prep courses fail to provide students with the specific skill sets to enable the students to succeed on the exam. Accordingly, there is a need for efficient and convenient education game systems and methods as described and claimed herein.

### BRIEF SUMMARY OF THE INVENTION

The present disclosure provides systems and methods for an educational game. Various examples of the system and method are provided herein.

The education game system disclosed herein provides an efficient, convenient, and inexpensive education game system that students may use to prepare for standardized tests. The education game system is more portable and convenient than conventional, printed test prep material. In addition, the exercises associated with the system do not require additional scrap paper to perform. Therefore, a student can take advantage of the time in between daily activities to conveniently practice test skills. Unlike the traditional test prep materials which focus on practicing sample problems and questions found on a standardized test, the system disclosed herein improves a student's performance by providing skill based exercises in a fun game-like format.

In an embodiment, the education game system comprises a controller and a memory coupled with the controller, where the memory is configured to store program instructions executable by the controller. In response to executing the program instructions, the controller is configured to display at least one key word and at least one distractor word simultaneously through a user interface. The words move across a screen of the user interface through a plurality of locations such that, at each point in time, each displayed key word and each displayed distractor word is associated with a current location. The key words may be, for example, pro-form words associated with standardized tests.

The controller is further configured to receive, through the user interface, a user selection location associated with a location on the screen of the user interface. In addition, the controller is configured to activate a first indication if the user selected location matches the current location associated with a key word and activate a second indication if the user selected location matches the current location associated with a distractor word.

The controller is further configured to access a database including a plurality of key words and a plurality of distractor words. In an example the words are organized in word sets within the database, such that each word sets is associated with a difficulty level.

Upon receiving a user action associated with a review page, the controller may be configured to display the review page that lists a plurality of key words. Further, upon receiving a user action associated with an explanation page, the controller displays an explanation page that includes text associated with the key word.

The plurality of key words and the plurality of distractor words move across a screen of the user interface through a plurality of locations for a predetermined time length. After the predetermined time length has passed, a summary page may be displayed that includes a list of key words associated with the second indication.

In an example, the activation of the first indication may include increasing a correct score, sounding a bell sound, replacing the selected key word with a green explosion, or combinations thereof.

The activation of the second indication may involve increasing an incorrect score, sounding a buzzer sound, replacing the selected distractor word with a red explosion, or combinations thereof.

The controller may be configured to provide a plurality of difficulty levels, wherein each plurality of difficulty level is associated with a speed at which words move across a screen of the user interface through a plurality of locations. In an example, the controller is configured to display the plurality of key words and the plurality of distractor words for a predetermined time length, wherein the speed of the words moving across the user interface increases as time lapses.

The disclosure also provides for an educational game system designed to help students with logical reasoning questions. In assumption type questions, the controller is configured to display evidence and a conclusion. The user can select a first option that identifies that the conclusion can be deduced from the evidence. Alternatively, the user can select a second option that identifies that the conclusion cannot be deduced from the evidence. In one example, the user selection of the first option may be by swiping the user interface from the displayed evidence to the displayed conclusion.

The disclosure also provides for an educational game system designed to help students recognize different types of questions. The controller is configured to display a question, the correct answer, and at least one incorrect answer.

The disclosure also provides for an educational game system designed to help students with determining the relationship between two items. The first item and second item may be words, phrases, numbers, symbols, or any other written representation of thought. The controller is configured to display a first item and second item. The system also displays at least one incorrect relationship and one correct relationship for the user to choose from.

The system is also configured to produce a diagnostic tree upon completion of any one of the games described above. For example, the system may ask a user a number of questions to determine what the user did incorrectly during the games in order to analyze the strengths and weakness of the user.

The system may also provide an immediate reward payout based on a user's performance. The rewards create an incentive for the user to continue to study and work towards abstract goals. The source of the money for the rewards may be from the user or a donor who places money into a study trust.

An advantage of the present systems and methods is that the system may be accessible through a portable electronic device, such as an iPhone, such that a student may accomplish quality studying without the need for test-prep books or scratch paper.

A further advantage of the present systems and methods is providing a student with short study sessions that can be performed in between daily activities, such as during a student's commute.

Another advantage of the present system is providing specific exercises for the student to master to improve his or her score on a test.

Yet another advantage of the present system is that the system provides a fun learning environment by presenting the exercises in a game-like format.

Another advantage of the present system is providing feedback associated with a lacking skill set associated with the incorrect answers, rather than feedback associated with the problem type of the incorrect answers.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an example of an embodiment of the system disclosed herein.

FIG. 2 is a front view of an example of key words and distractor words displayed on a user interface.

FIG. 3 is a front view of an example of a display of an explanation prompt disclosed here in on a user interface.

FIG. 4 is a front view of an example of a display of an explanation page disclosed herein on a user interface.

FIG. 5 is a front view of an example of a display of a summary page disclosed herein on a user interface.

FIG. 6 is a front view of an example of a display of an evidence and conclusion game disclosed herein on a user interface.

FIG. 7 is a front view of an example of a display of a summary page disclosed herein on a user interface.

FIG. 8 is a front view of an example of a display of a question and answer game disclosed herein on a user interface.

FIG. 9 is a front view of an example of a display of a summary page disclosed herein on a user interface.

FIG. 10 is a front view of an example of a display of relationship game disclosed herein on a user interface.

FIG. 11 is a front view of an example of a display of a summary page disclosed herein on a user interface.

FIG. 12 is a flow chart of an embodiment of a diagnostic tree according to the disclosed invention.

### DETAILED DESCRIPTION OF THE INVENTION

The educational game system disclosed herein provides students with various skill-based exercises aimed at improving their scores on standardized tests. Unlike traditional test-prep materials that provide sample problems associated with standardized tests, the present system provides game-like exercises for students to develop specific skills that will improve their speed and accuracy on the exam.

Standardized exams often contain key words that, if recognized by students, make a substantial improvement in their overall score. These key words are often pro-form words. A pro-form is a function word that expresses the same content as another word or phrase (an antecedent) wherein the meaning of the pro-form is deduced from the context. Examples of pro-forms include pronouns, pro-adjectives, pro-adverb, pro-verb, and pro-sentence. In addition to pro-form words, the key words may also be words that signal the to the reader a consistency or change in perspective, such as “similarly.” Specific examples of key words include “yet,” “him,” “they,” “in contrast,” “however,” etc.

The writers of standardized exams use these small, seemingly inconsequential words to engineer right and wrong answer choices. For example, standardized exams regularly use two or three pro-forms to refer to the same antecedent and then proceed to ask a question about statements that contain the pro-forms. Therefore, if a student has not continuously linked the pro-forms to their antecedents, the student will be forced to reread the passage to understand the question, thereby losing precious time during the exam, which will be reflected in the student's final score. In contrast, students who learn to locate and apply these key words when making their answer selection may increase the overall score of their exam.

The present educational game system streams key words and distractor words across a user interface, such as a touch screen of an electronic device. Students must select the key words, generally by tapping on the image of the key word, before the key words exit the screen and refrain from tapping the distractor words. The system trains a student's mind to quickly filter distracting words from key words, a skill that will enhance the overall score of their exam.

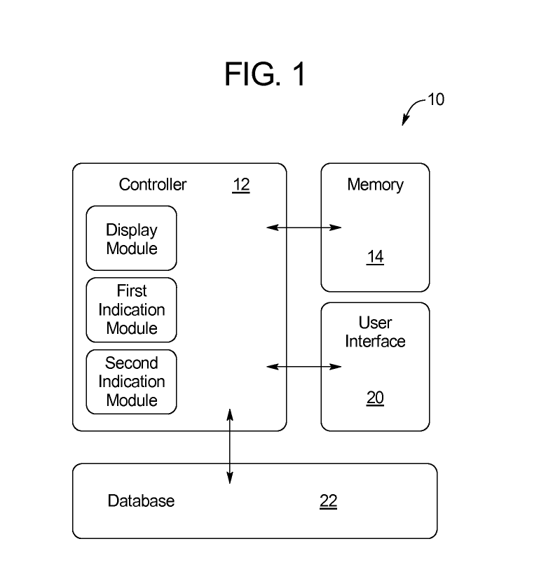

As depicted in FIG. 1, the education game system 10 comprises a controller 12 and a memory 14 coupled with the controller, where the memory 14 is configured to store program instructions executable by the controller 12.

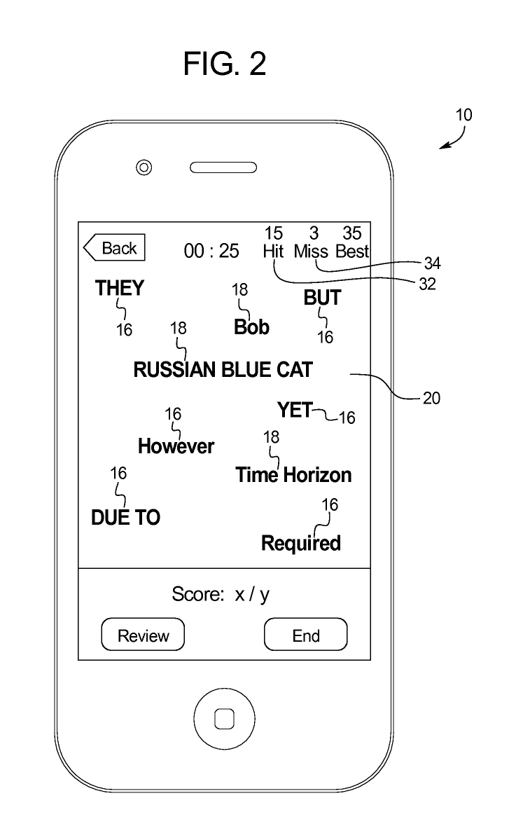

In response to executing the program instructions, the controller 12 is configured to display at least one key word 16 and at least one distractor word 18 simultaneously through a user interface 20. The words to move across a screen of the user interface 20 through a plurality of locations such that, at each point in time, each displayed key word 16 and each displayed distractor word 18 is associated with a current location. FIG. 2 shows an example of a user interface 20 at one point in time with various key words 16 and distractor words 18 displayed at various locations. The words displayed may have different sizes, different fonts, and move at different speeds across the user interface 20.

The key words 16 and distractor words 18 may be stored in a database 22 accessible by the controller 12. In addition, the words may be organized in word sets associated with different difficulty levels. For example, a word set associated with a more difficult level may contain a plurality of key words 16 that are more difficult to distinguish from the plurality of distractor words 18.

Different difficulty levels may not only be based on the word sets, but alternatively, or in addition to, the speed at which the words move across the user interface 20. For example, more difficult levels may be associated with moving the words across a screen of the user interface 20 through a plurality of locations at a faster speed.

The controller 12 is further configured to receive, through the user interface 20, a user selection location 24 associated with a location on the screen of the user interface 20. Further, a first indication is activated if the user selected location 24 matches a current location associated with a key word 16 and a second indication is activated if the user selected location 24 matches a current location associated with a distractor word 18. In other words, if the user selects, again, generally by tapping on the user interface 20, a key word 18, a first indication is activated. If the user selects a distractor word 18, a second indication is activated.

The first indication may include increasing a correct score 32. For example, as shown in FIG. 2, the number of hits may be increased incrementally for every key word 16 selected. Alternatively, or in addition to, the first indication could also include a visual or audio indication. In an example, the first indication may have the key word 16 selected by the user morph into a green explosion and disappear from view. The first indication may also include a positive sound, such as a bell sound.

The second indication may include increasing an incorrect score 34. The incorrect score 34 may be associated with the number of key words 16 that are not selected that appear on the user interface 20. For example, as shown in FIG. 2, the number of misses may be increased incrementally for every key word 16 that makes its way across the user interface 20 without being selected by the user. Alternatively, or in addition, the incorrect score 34 may be associated with the number of distractor words 18 that the user selects. The second indication could also include a visual or audio indication. In an example, the second indication may have a distractor word 18 selected by the user morph into a red explosion and disappear from view. The second indication may also include a negative sound, such as a buzzer sound.

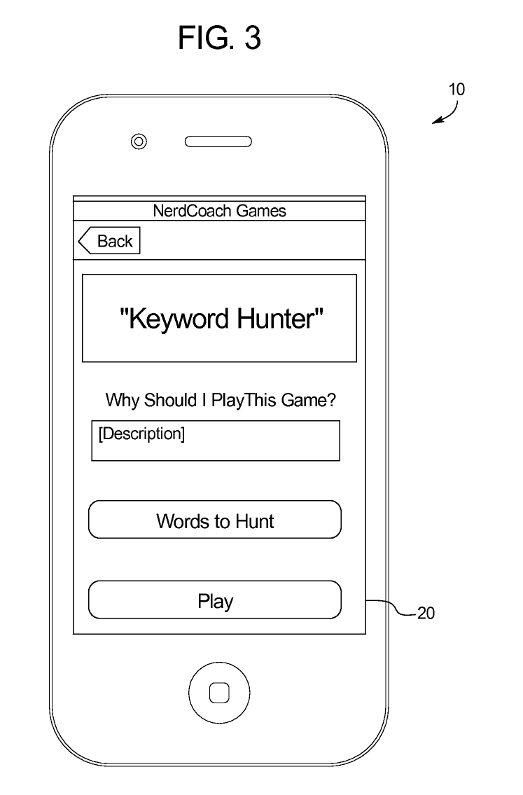

During the game, as the words are moving across the user interface 20, the controller 12 is further configured to pause or the end the game to display a key word page 36. The key word page 36 may also be accessed before or after the game. As shown in FIG. 2, the user may select the “Review” prompt to access the key word page 36 during the game. In addition, the key word page 36 may be accessed from a home page. For example, FIG. 3 shows an example of a display on a user interface 20 before the game starts. As shown, the user can select to start the game by tapping “play” or the user can review the key words 16 by tapping “words to hunt.”

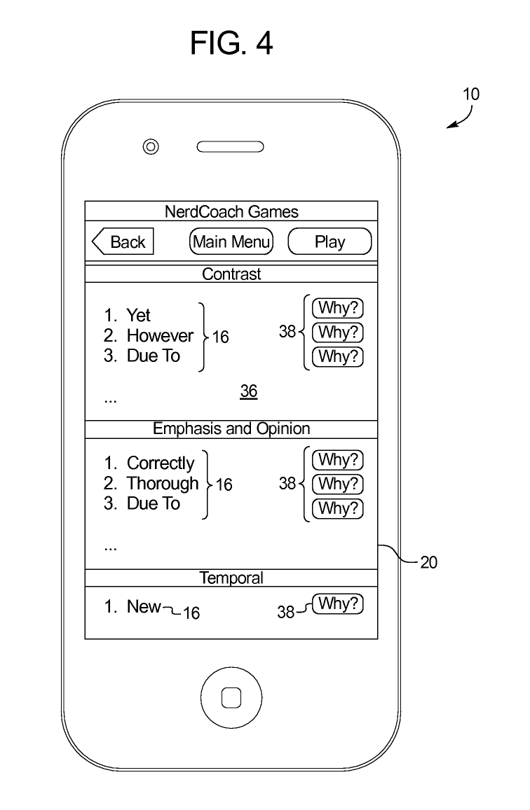

FIG. 4 is an example of a display on the user interface 20 of a key word page 36. As shown, the key word page 36 lists a plurality of key words 16 and an explanation prompt 38 associated with each key word 16 listed. Upon receiving a user action associated with the explanation prompt 38, an explanation page is displayed that includes text associated with the selected key word 16. For example, if the user selected the explanation prompt 38 associated with the word “yet,” the explanation page associated with the word “yet” would be displayed as the key word page 36 and provide text explaining why “yet” is a key word 16 that the user should know for the exam.

The controller 12 is configured to display the plurality of key words 16 and the plurality of distractor words 18 across a screen of the user interface 20 through a plurality of locations for a predetermined time length. The predetermined time could be any suitable time, such as 30 seconds, 1 minute, 2 minutes, 3 minutes, 5 minutes, 10 minutes, or 15 minutes. In addition, the user may customize the predetermined time length. In one example, the speed of the words moving across the user interface 20 increases as time lapses.

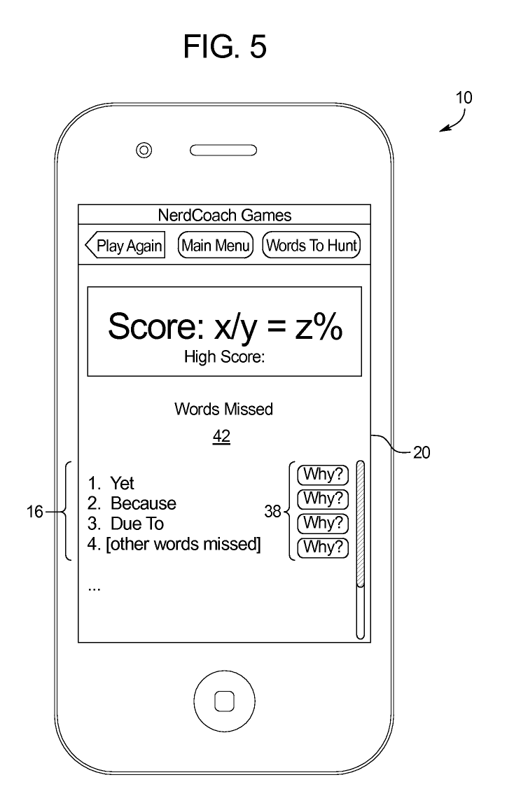

Upon conclusion of the predetermined time or upon the user selecting a predetermined amount of key words 16, the controller 12 is configured to display a summary page 42. For example, as shown in FIG. 5, the summary page 42 includes a list of key words 16 associated with the second indication. For example, the list of words on the summary page 42 may be the key words 16 that the user missed identifying during the game. The summary page 42 may also include a list of distractor words 18 that the user selected incorrectly.

The summary page 42 may also include an explanation prompt 38 associated with each key word 16 listed. A user may select the explanation prompt 38 for the system 10 to display an explanation page associated with the key word 16 selected in order to review why the key word 16 is important. The summary page 42 may also display the overall score the user obtained during the predetermined time length. The score could be the number of key words 16 the user correctly identified, indicated as “x” in FIG. 5, out of the number of key words 16 that were displayed during the predetermined time length, indicated as “y” in FIG. 5. The percent of the key words 16 correctly identified may also be displayed, as indicated as “z” in FIG. 5.

The disclosure also provides for an educational game system 10 designed to help students with logical reasoning questions. In assumption type questions, the conclusion cannot be deduced from the evidence without the application of an assumption. The key to excelling in assumption questions is to identify the difference between the evidence and conclusion. The system 10 disclosed herein trains students to identify the difference in seemingly identical evidence and conclusions in order to pick the correct assumption answers.

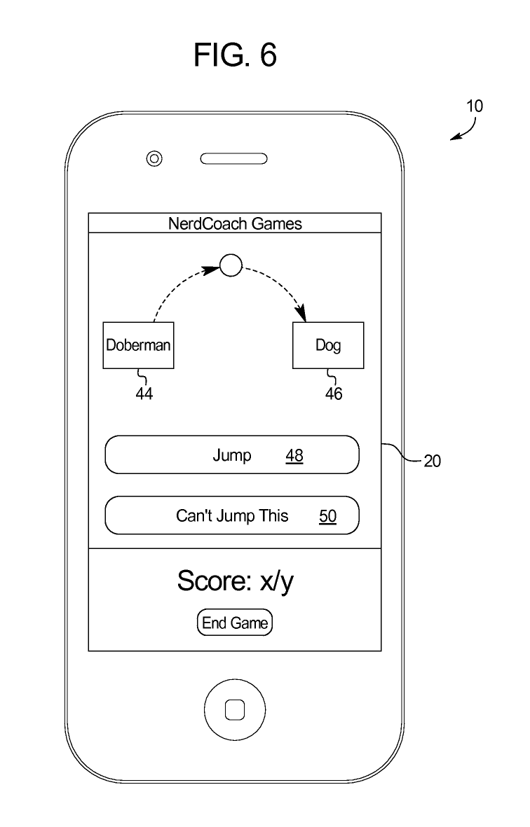

As shown in FIG. 6, the controller 12 is configured to display evidence 44 and a conclusion 46. The evidence 44 and conclusion 46 may be words, phrases, numbers, symbols, or any other written representation of thought. The evidence 44 and conclusions 46 may be organized within the database 22 in corresponding idea pairs.

The user can select a first option 48 that identifies the conclusion 46 can be deduced from the evidence 44. In other words, if the user believes the evidence 44 is sufficient to conclude the conclusion 46, the user selects a first option 48, illustrated as “jump” in FIG. 6. Alternatively, the user can select a second option 50, such as “can't jump this” in FIG. 6, which identifies that the conclusion 44 cannot be deduced from the evidence 44. In one example, the user selection of the first option 48 may be by swiping the user interface 20 from the displayed evidence 44 to the displayed conclusion 46.

The selection of the first option 48 may be associated with a first indication and the selection of the second option 50 may be associated with a second indication. As discussed above, the first indication and second indication may be associated with an increase or decrease in score, as well as visual and audio effects. In one example, the first indication may be associated with a visual effect that has an object jumping from the evidence 44 to the conclusion 46, as shown in FIG. 6.

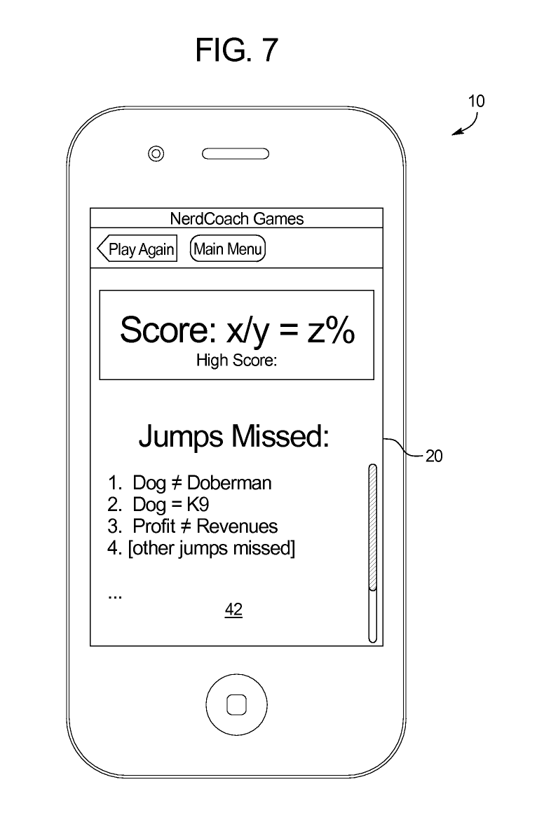

As shown in FIG. 7, after the conclusion of a predetermined time length or a predetermined number of questions answered, the controller 12 is configured to display a summary page 42. The summary page 42 is a display of the problems the user incorrectly answered as well as the user's score. In addition, the summary page 42 may also include an explanation prompt 38, such that upon selection of the explanation prompt 38, an explanation page is displayed. The explanation page provides text detailing why or why not the conclusion 46 can be deduced from the evidence 44 for each of the problems the user incorrectly answered.

The disclosure also provides for an educational game system 10 designed to help students recognize different types of questions. In order to answer a question, a student must know what the question is asking. Standardized tests use a variety of ways to ask the same questions, and each question type has its own answer strategy. Therefore, for a student to quickly answer a question, the student must recognize the type of question to know what answer strategy should be used.

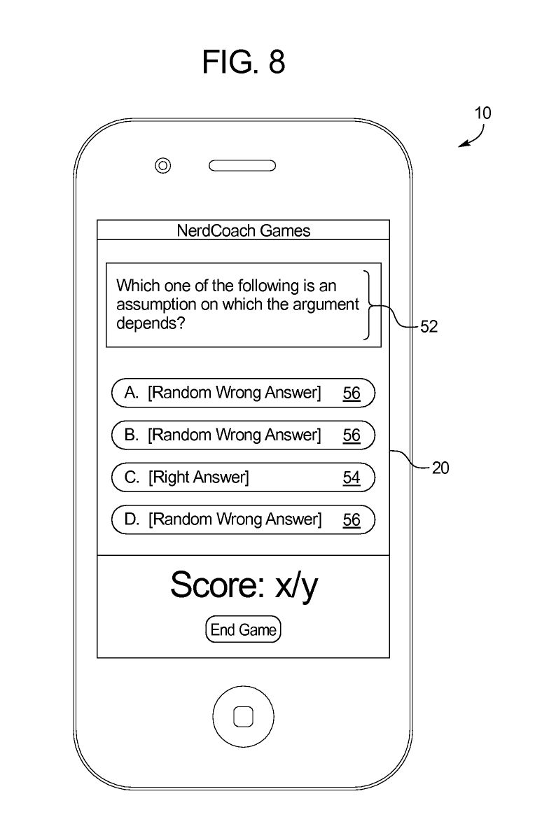

The system 10 also provides a game to help students identify the type of question presented. As shown in FIG. 8, the controller 12 is configured to display a question 52. Along with the question 52, the correct answer 54 and at least one incorrect answer 56 are displayed.

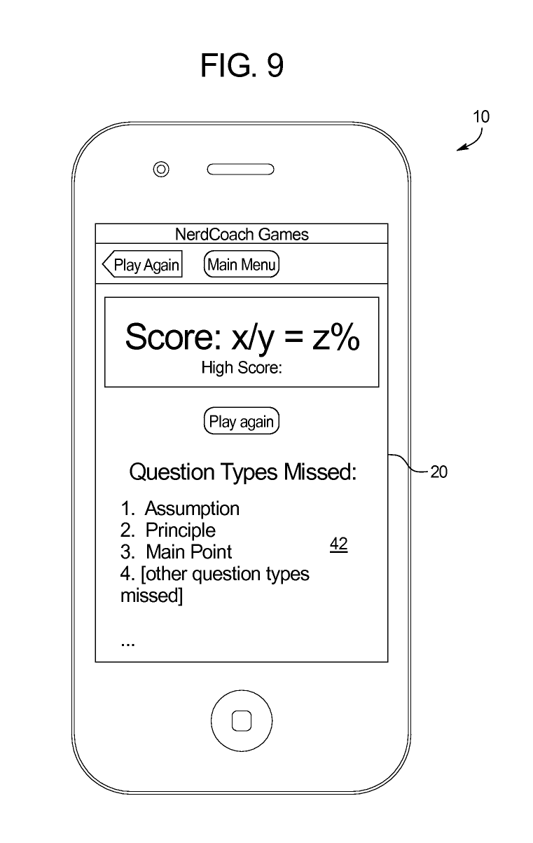

After a predetermined amount of time passes or a predetermined number of questions 52 are answered, the controller 12 is configured to display a summary page 42, as shown in FIG. 9. The summary page 42 is a display of the problems the user incorrectly answered as well as the user's score. In addition, the summary page 42 may also include an explanation prompt 38, such that upon selection of the explanation prompt 38, an explanation page is displayed. As explained above, the explanation page provides text detailing the correct answers 56 for the questions 52 the user incorrectly identified.

The disclosure also provides for an educational game system 10 designed to help students with determining the relationship between two items. The first item 60 and second item 62 may be words, phrases, numbers, symbols, or any other written representation of thought.

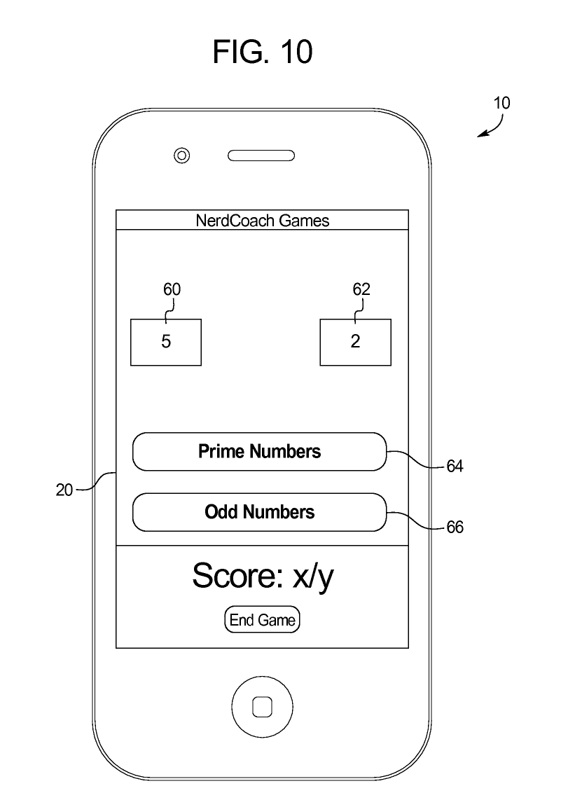

As shown in FIG. 10, the controller 12 is configured to display a first item 60 and second item 62. The first item 60 and second item 62 may be organized in the database 22 in pairs, such that the pairs are tagged with the type of relationship between the two items. For example, the relationship between two items 60, 62 is the correct answer and indicates the relationship between the first item 60 and second item 62. The system 10 also displays at least one incorrect relationship 66 and one correct relationship 64 from which the user may make a selection.

The selection of the correct relationship 64 may be associated with a first indication and the selection of the incorrect relationship 66 may be associated with a second indication. As discussed above, the first indication and second indication may be associated with an increase or decrease in score, as well as visual and audio effects.

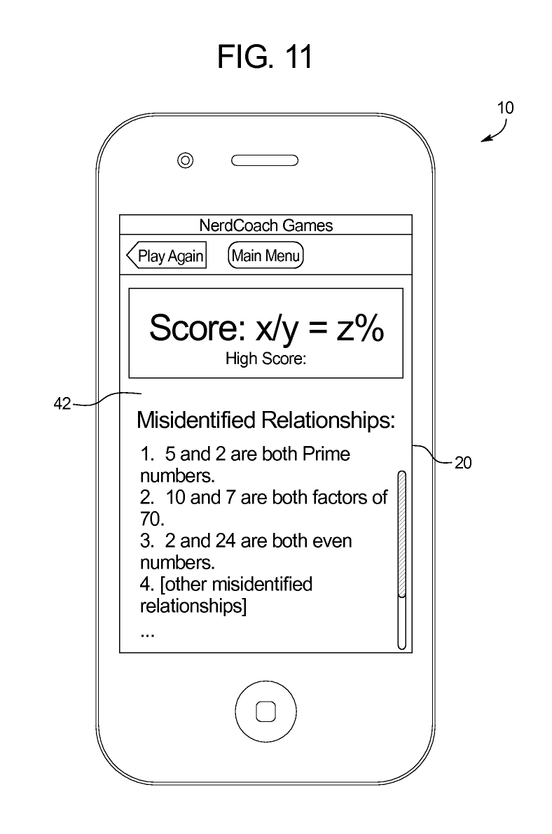

As shown in FIG. 11, after the conclusion of a predetermined time length or a predetermined number of correctly identified relationships, the controller 12 is configured to display a summary page 42. The summary page 42 is a display of the problems the user incorrectly answered as well as the user's score. In addition, the summary page 42 may also include text detailing the correct relationship 64 between the items associated with problems the user answered incorrectly.

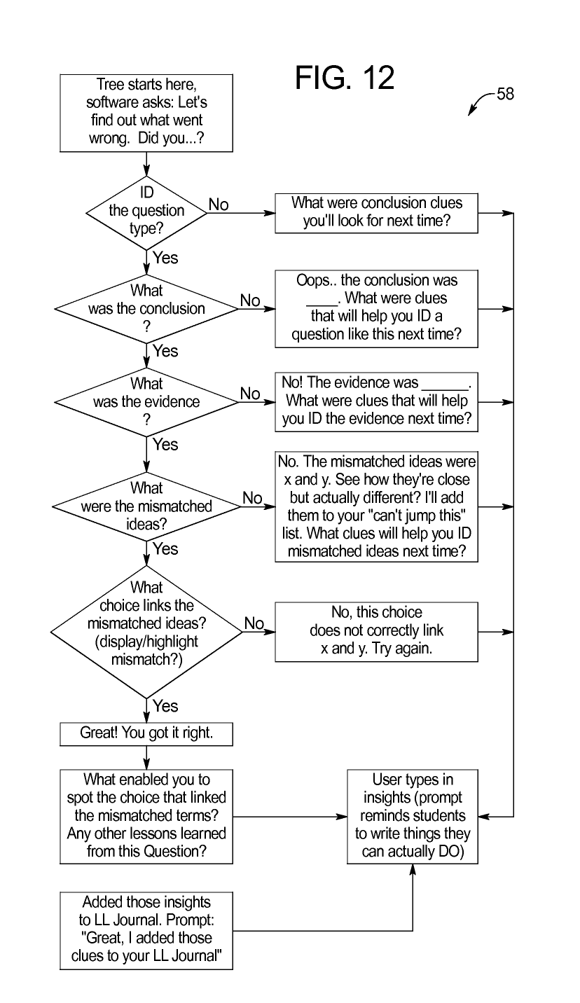

The system 10 is also configured to produce a diagnostic tree 58 upon completion of any one of the games described above. As shown in the flow chart of FIG. 12, the system 10 asks a user a number of questions to determine what the user did incorrectly during the games in order to analyze the strengths and weakness of the user. FIG. 12 shows a diagnostic tree 58 associated with assumption type questions. The system 10 may present the user with a problem that was answered incorrectly and walk the user through identifying what the evidence 44 and conclusion 46 were for the question if the user identified the evidence 44 or conclusion 46 incorrectly. The system 10 allows a user to enter text associated with lessons the user learned from the incorrect answers that is then stored in a journal associated with the user. The journal, which may be stored in the database 16, comprises personal notes, reminders, and conclusions learned from the exercises that can be reviewed before an exam day.

The system 10 also provides an immediate reward payout based on a user's performance. The rewards create an incentive for the user to continue to study and work towards abstract goals. The source of the money for the rewards may be from the user or a donor who places money into a study trust.

The rewards may be paid to the user upon completion of certain tasks. Such tasks may include quizzes, problem sets, full-length exams, or after obtaining a sufficient score in any a particular problem set or evaluation. The amount of money paid out to the user may be based on the user's performance of the task. For example, the user would receive a higher reward for a higher score, and a lower reward for a lower score.

It is contemplated that the rewards may be paid, not only from the user's study trust, but also from other users' study trusts. For example, a bonus task may enable a user to earn money from another user's study trust.

Although the description thus far has indicated a visual format of producing questions and receiving answers from a user, it is contemplated that the system 10 may be configured to verbally ask the user questions in order to help the user prepare for standardized tests. The system 10 is also configured to receive oral answers from the user using voice commands. Therefore, the system 10 enables a user to study while driving or doing any other task that requires his or her hands.

As shown in FIG. 1, aspects of the systems and methods described herein are controlled by one or more controllers 12. The one or more controllers 12 may be adapted to run a variety of application programs, access and store data, including accessing and storing data in associated databases 22, and enable one or more interactions as described herein. Typically, the one or more controllers 12 are implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memory 14 and an interconnect bus. The CPU may contain a single microprocessor, or it may contain a plurality of microprocessors for configuring the CPU as a multi-processor system. The memory 14 include a main memory, such as a dynamic random access memory (DRAM) and cache, as well as a read only memory, such as a PROM, EPROM, FLASH-EPROM, or the like. The system may also include any form of volatile or non-volatile memory 14. In operation, the memory 14 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller 12. For example, the one or more controllers 12 may include a graphics subsystem to drive the output mechanism. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and device may be provided based on various combinations of the features and functions from the subject matter provided herein.

We claim:

1. An education game system comprising:
a controller; and
a memory coupled to the controller, wherein the memory is configured to store program instructions executable by the controller,
wherein, in response to executing the program instructions, the controller is configured to:
display at least one key word and at least one distractor word simultaneously through a user interface and cause the words to move across a screen of the user interface through a plurality of locations such that, at each point in time, each displayed key word and each displayed distractor word is associated with a current location;
receive, through the user interface, a user selection location associated with a location on the screen of the user interface;
activate a first indication if the user selected location matches the current location associated with the key word; and
activate a second indication if the user selected location matches the current location associated with the distractor word.

2. The system of claim 1 wherein the controller is further configured to access a database including a plurality of key words and a plurality of distractor words.

3. The system of claim 1 wherein the controller is configured to access a database comprising a plurality of word sets, wherein each of the plurality of word sets include a plurality of key words and a plurality of distractor words, wherein each of the plurality of word sets is associated with a difficulty level.

4. The system of claim 1 wherein the controller is further configured to display a review page, upon receiving a user action associated with a review page, wherein the review page lists a plurality of key words.

5. The system of claim 1 wherein the controller is further configured to display an explanation page, upon receiving a user action associated with the explanation page, wherein the explanation page includes text associated with the key word.

6. The system of claim 1 wherein the controller is configured to display the plurality of key words and the plurality of distractor words across a screen of the user interface through a plurality of locations for a predetermined time length.

7. The system of claim 1 wherein the controller is configured to display a summary page after a predetermined time length, wherein the summary page comprises a list of key words associated with the second indication.

8. The system of claim 1 wherein the activation of the first indication increases a correct score.

9. The system of claim 1 wherein the activation of the second indication increases an incorrect score.

10. The system of claim 1 wherein the controller is configured to provide a plurality of difficulty levels, wherein each plurality of difficulty level is associated with a speed at which words move across a screen of the user interface through a plurality of locations.

11. The system of claim 1 wherein the first indication replaces the displayed key word with a green explosion.

12. The system of claim 1 wherein the second indication replaces the distractor word with a red explosion.

13. The system of claim 1 wherein the first indication comprises a bell sound.

14. The system of claim 1 wherein the second indication comprises a buzzer sound.

15. The system of claim 1 wherein the words that move across a screen of the user interface have a plurality of sizes.

16. The system of claim 1 wherein the controller is configured to display the plurality of key words and the plurality of distractor words for a predetermined time length, wherein the speed of the words moving across the user interface increases as time lapses.

17. The system of claim 1 wherein the key words are pro-form words associated with standardized tests.

18. The system of claim 1 wherein the distractor words are not pro-form words.
